(19) United States
(12) Patent Application Publication
(10) Pub. No.: US 2010/0121674 A1
(43) Pub. Date: May 13, 2010

(54) APPARATUS AND METHOD FOR GENERATING SCHEDULE CONSIDERING ATTENDANTS' CONTEXT IN MOBILE COMMUNICATION TERMINAL

(75) Inventors: Yong-Ju Yu, Seoul (KR); Jung-Sic Sung, Yongin-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/608,710

(22) Filed: Oct. 29, 2009

(30) Foreign Application Priority Data
Nov. 12, 2008 (KR) 10-2008-0112140

(51) Int. Cl. G06Q 10/00; G01C 21/00

(52) U.S. Cl. 705/9; 701/201; 701/213

(57) ABSTRACT

An apparatus and a method for generating a schedule considering attendants' context in a mobile communication terminal are provided. The method includes obtaining location information of attendants, determining a travel time for each attendant to travel to a location of a schedule to be generated using the obtained location information, displaying the determined travel time on a time table in the form of a time limit.

### PRIORITY

This application claims the benefit under 35 U.S.C. §119(a) of a Korean patent application filed in the Korean Intellectual Property Office on Nov. 12, 2008 and assigned Serial No. 10-2008-0112140, the entire disclosure of which is hereby incorporated by reference.

### BACKGROUND OF THE INVENTION

1. Field of the Invention

The present invention relates to an apparatus and a method for generating a schedule based on attendants' context in a mobile communication terminal More particularly, the present invention relates to an apparatus and a method for generating a schedule within a compressed time frame range, allowing a user to select a suitable time frame within the compressed time frame range and displaying the time frame.

2. Description of the Related Art

Mobile communication terminals are widely distributed due to their convenience in portability. Therefore, service providers (i.e., terminal manufacturers) competitively develop terminals having more functions in order to secure many users. For example, a mobile communication terminal provides various functions, such as a phone book, games, a scheduler, a Short Message, Internet access, electronic (E)-mail, an alarm, a Motion Picture Expert Group Audio Layer-3 (MP3) player, a digital camera, an electronic dictionary, and the like.

The scheduler of the mobile communication terminal is designed for managing a schedule of a user. The scheduler not only manages a private schedule of a user, but also shares the schedule with other users and generates a new schedule together with the other users' schedules.

Currently, a schedule management support software, such as ‘Outlook’, provides a function for sharing a schedule with other users. When a user intends to generate a new meeting schedule with other users, the user displays schedules shared with the other users on the user's schedule table using the schedule sharing function, and compares the displayed schedules of the other users with the user's schedule to generate the meeting schedule in a time frame where no schedule is set.

However, when determining a time frame where a new schedule may be generated, a user simply considers only a time frame where a schedule has been already set, and does not consider schedule contexts of other users. More particularly, since all schedules include time and location, the location is an important factor relevant to the time. Therefore, when determining a time frame where a schedule can be generated, consideration of the location is required. For example, if previous schedules of some of the users who should attend a new schedule are located a far distant away from a location of the new schedule, the amount of time for allowing the users to travel from the previous locations and arrive at the new scheduled location are not considered on a general schedule table. Even when a user who generates a new schedule checks all parts of the schedule and generates a schedule with a margin, the user will have to verify in person all schedules of other users one by one, which is complicated and requires a lot of time.

Therefore, a need exits for an apparatus and method for generating a schedule within a compressed time frame to be selected.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for generating a schedule considering attendants' context in a mobile communication terminal.

Another aspect of the present invention is to provide an apparatus and a method for allowing a user to select a suitable time frame and generate a schedule within a compressed range by generating a time frame in which each attendant actually arrives at a scheduled location and perform the schedule within a time limit, based on attendants' context, such as locations, and displaying the time frame when generating a schedule in a mobile communication terminal.

Still another aspect of the present invention is to provide an apparatus and a method for collecting external data, for example, information regarding time tables and reservation status of a transportation means (e.g., airplanes, railroads, limousine buses, and the like), weather conditions, road status, and the like, which allows for a more accurate estimation of travel time for each attendant to depart from a location of a previous schedule and arrive at a location of a new schedule, and for determining a time frame in which a schedule can be performed through the estimated travel time.

In accordance with an aspect of the present invention, a method for generating a schedule of a mobile communication terminal is provided. The method includes obtaining location information of attendants, determining a travel time for each attendant to travel to a scheduled location to be generated using the obtained location information, and displaying the determined travel time on a time table in the form of a time limit.

In accordance with another aspect of the present invention, an apparatus for generating a schedule of a mobile communication terminal is provided. The apparatus includes a schedule information collector for obtaining location information of attendants, an external data processor for determining a travel time for each attendant to travel to a scheduled location to be generated using the obtained location information, and a controller for displaying the determined travel time on a time table in the form of a time limit, and providing the time limit to a display unit.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1A and 1B are exemplary views illustrating a time frame limit based on attendants' context in a mobile communication terminal according to an exemplary embodiment of the present invention;

FIG. 2 is a block diagram illustrating an apparatus of a mobile communication terminal according to an exemplary embodiment of the present invention;

FIG. 3 is a flowchart illustrating a method for generating a schedule based on attendants' context in a mobile communication terminal according to an exemplary embodiment of the present invention;

FIG. 4 is a view illustrating a user interface for receiving location information in a schedule generation menu of a mobile communication terminal according to an exemplary embodiment of the present invention;

FIGS. 5A and 5B are views illustrating a table representing estimated consumed travel time for each domestic/overseas region of a mobile communication terminal according to an exemplary embodiment of the present invention;

FIG. 6 is a flowchart illustrating a method for determining travel time of an attendant using external data when generating a schedule in a mobile communication terminal according to an exemplary embodiment of the present invention; and

FIG. 7 is a view illustrating an operating time table collecting process for transportation means in a mobile communication terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide an apparatus and a method for generating a schedule based on attendants' context in a mobile communication terminal.

Although exemplary embodiments of the present invention are described with reference to using a mobile communication terminal, for example, the present invention is applicable to all systems supporting schedule management, and more particularly, useful for a business-specialized system.

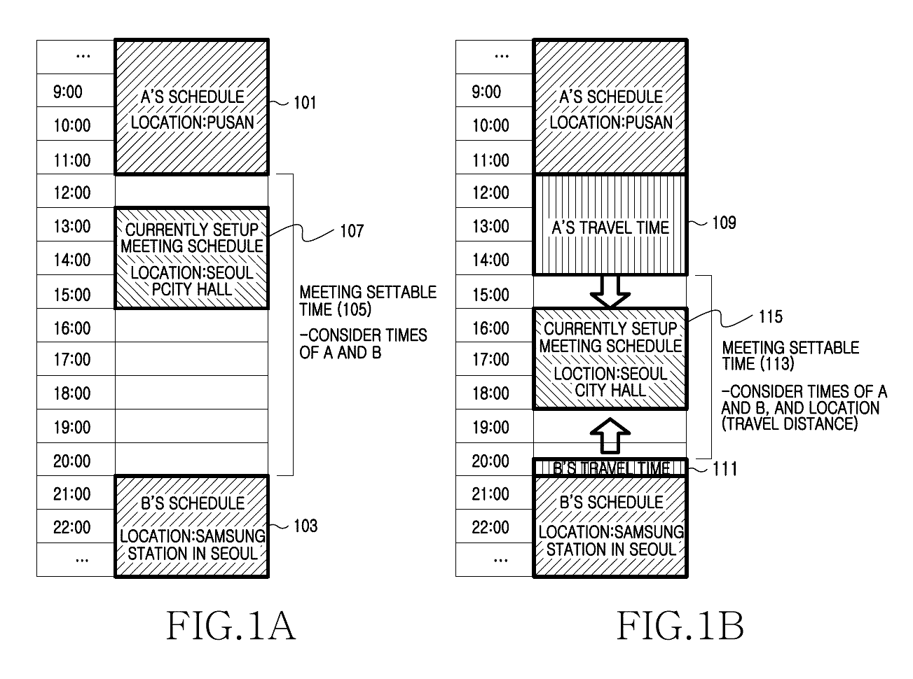

Conventionally, a user may generate a new schedule in a vacant time frame by considering only scheduled time information when generating the new schedule by sharing schedule information of attendants. Here, a time frame limit based on each attendant's time with respect to a meeting schedule being currently set is described in FIG. 1A, for example. It is assumed that the meeting schedule has been set at Seoul City Hall for three hours and attendants A and B are attending the scheduled meeting. In addition, it is assumed that attendant A has a schedule 101 in Pusan until 12:00 on the date in which the meeting schedule has been set, and attendant B has a schedule 103 at Samsung station in Seoul after 21:00. In this case, when a time frame limit is generated based on attendants' A and B time, a settable meeting time 105 becomes a time frame between 12:00 and 21:00. Accordingly, the meeting schedule is set in a time frame 107 between 13:00 and 16:00. However, in this case, it would be difficult for attendant A to depart from Pusan and attend the scheduled meeting at Seoul City Hall within a scheduled time because travel time has not been considered.

In contrast, in an exemplary implementation, a new schedule at a vacant time frame considering location information as well as time information is generated. Also, a schedule considering various context information including the location information is generated.

FIG. 1B is an exemplary view illustrating a time limit frame based on time of each attendant and a location (that is, location travel time) with respect to a meeting schedule which is currently being set.

Referring to FIG. 1B, time 109 taken for attendant A to travel from Pusan, which is a location of a previous schedule, to Seoul City Hall, which is a location of a scheduled meeting, is three hours. Time 111 taken for attendant B to travel from Seoul City Hall, which is the location of the scheduled meeting, to Samsung station in Seoul, which is the location of a next schedule, is thirty minutes. As a result, a settable meeting time frame 113 is limited between 15:00 and 20:30. Therefore, the meeting schedule is settable at a time frame 115 between 16:00 to 19:00. This time schedule is in contrast to the generating of a schedule between 12:00 and 21:00 in FIG. 1A.

Various context information may include information of a schedule's disabled state due to a long term activity location change status, such as a long term business trip, travel, and the like, a health state, such as hospital treatment, pregnancy, and the like, and other states, such as military training, national examination, and the like. In an exemplary implementation, various contexts may be provided to a user so that the user may reflect on the various contexts when making a schedule.

As described above, when contexts, more particularly, locations of attendants are considered when generating a schedule, a time frame range of a user's schedule management may be provided to the user, which enables the user to quickly and accurately make a decision.

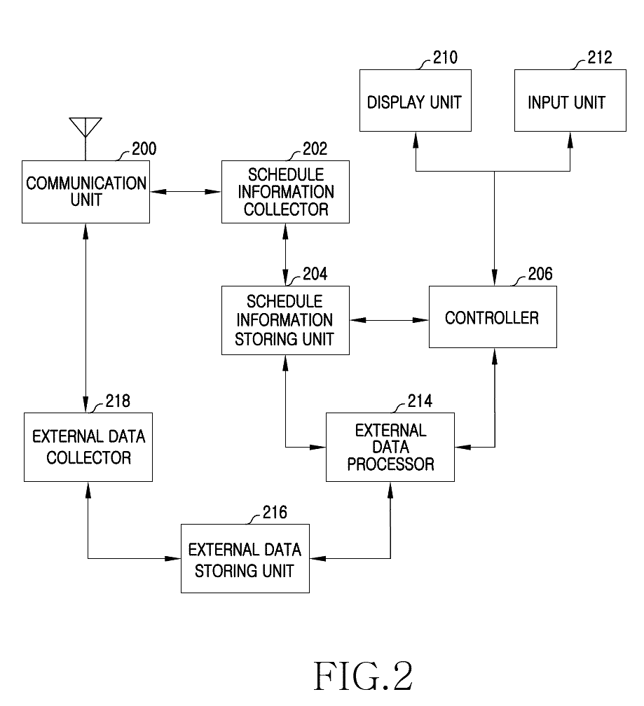

FIG. 2 is a block diagram illustrating an apparatus of a mobile communication terminal according to an exemplary embodiment of the present invention.

Referring to FIG. 2, the mobile communication terminal includes a communication unit 200, a schedule information collector 202, a schedule information storing unit 204, a controller 206, a display unit 210, an input unit 212, an external data processor 214, an external data storing unit 216 and an external data collector 218.

The communication unit 200 processes a signal transmitted/received via an antenna.

The schedule information collector 202 collects schedule information of each attendant when generating a schedule. Here, the schedule information denotes time information, location information, and other various context information of a schedule already set on a date in which the schedule is to be set.

The schedule information storing unit 204 stores the collected schedule information of each attendant.

The controller 206 shares schedule information with each attendant and generates a primary time limit of a time table using time information obtained through the schedule information sharing. In addition, the controller 206 requests the external data processor 214 to process information requiring additional external data process, that is, location information and context information, receives time limit information (e.g., time for travel to a scheduled location) generated by performing an additional external data process on the location information and the context information from the external data processor 214, and generates a secondary time limit of the time table using the received time limit information. In addition, the controller 206 provides the generated primary time limit and secondary time limit to the display unit 210 together with the time table. Therefore, a user may select a suitable time frame for generating a schedule within a compressed range. Accordingly, the controller 206 receives the selected time frame through the input unit 212 and generates a schedule in the provided time frame. In addition, the controller 206 stores information regarding the generated schedule, the primary time limit and the secondary time limit, and the time limit information in the schedule information storing unit 204 or a separate database. Here, the information regarding the schedule and the time limit information may then be shared with the attendants.

The display unit 210 displays state information, numbers and letters generated during an operation of the mobile communication terminal.

The input unit 212 includes a plurality of function keys and provides data corresponding to a key pressed by a user to the controller 206.

The external data processor 214 extracts the location information and the context information from the schedule information storing unit 204 in response to an additional external data process request for the location information and the context information from the controller 206. The external data processor 214 stores the extracted information in the external data storing unit 216. The external data processor 214 then extracts external data updated by the external data collector 218, that is, external data corresponding to the location information and the context information from the external data storing unit 216, generates the time limit information (e.g., time for travel to a scheduled location) using the extracted external data, and provides the time limit information to the controller 206.

The external data storing unit 216 stores an estimation table (e.g., consumed travel time table for each region) input in advance, and external data that should be updated by the external data collector 218.

The external data collector 218 periodically checks the external data storing unit 216, searches for external data that needs to be updated, and updates the external data storing unit 216 using the searched external data.

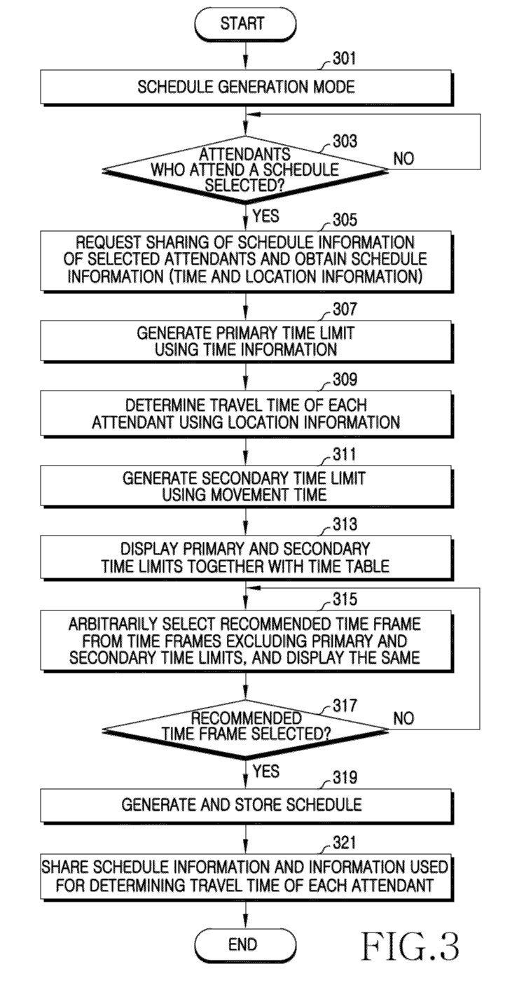

FIG. 3 is a flowchart illustrating a method for generating a schedule based on attendants' context in a mobile communication terminal according to an exemplary embodiment of the present invention.

Referring to FIG. 3, when a user selects a menu, the terminal enters a schedule generation mode for a date in which a new schedule is to be generated in step 301.

The terminal determines whether one or more attendants who will attend a schedule are selected, depending on the user's key input in step 303. When one or more attendants are selected, the terminal requests the selected one or more attendants to share schedule information set in advance on a date, and obtains time information and location information on the scheduled date in step 305. For this purpose, a prior agreement for schedule information sharing is required between the terminal and the one or more attendants. To include location information in the schedule information, the location information should be input from a user during generation of a schedule.

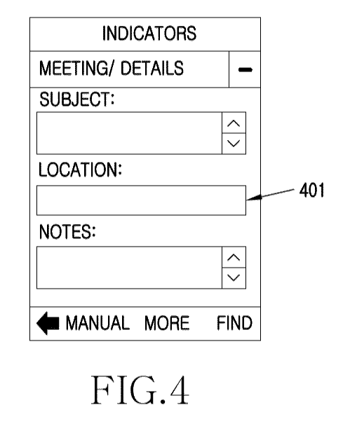

FIG. 4 is a view illustrating a user interface for receiving location information in a schedule generation menu according to an exemplary embodiment of the present invention. A user should input location information 401 as schedule information when adding a schedule to a scheduler for himself.

When location information for a schedule is not included in the schedule information of attendants obtained through the schedule information sharing, the terminal may receive Global Positioning System (GPS) information for current locations of the attendants and use the received GPS information as the location information. Alternatively, the terminal may receive, in advance, information for primary activity regions and residential regions of the attendants as information for the attendants from a user, and use the received information as the location information. The GPS information of the attendants' locations that are frequently set may be set as the information for the primary activity regions. Priority may be set among the location information. In an exemplary implementation, schedule information of attendants obtained through the schedule information sharing is set as location information having highest priority.

Referring back to FIG. 3, the terminal generates a primary time limit of a time table using scheduled time information of one or more attendants in step 307. That is, the terminal expresses a start time and an end time of each schedule on the time table as illustrated in FIG. 1A using the start time and the end time of each schedule set in advance on a date.

The terminal determines travel time of each attendant using location information of the schedule information in step 309. That is, the terminal determines a time for travel to a newly scheduled location to be generated from a previously scheduled location of each attendant set in advance on a date.

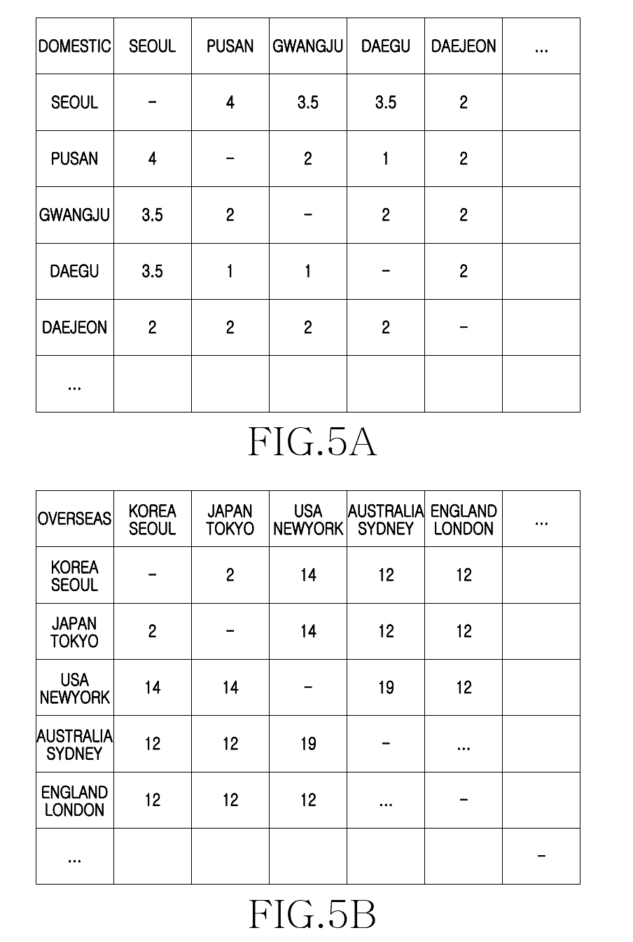

Here, the travel time may be determined using a table that stores estimated consumed travel time for each region. For this purpose, the terminal may have an estimated consumed travel time storing unit for each region separately. The table stored in the estimated consumed travel time storing unit for each region may be an updatable table. For example, the estimated consumed travel time storing unit for each region may store a table representing an estimated consumed travel time for each domestic region as illustrated in FIG. 5A, and a table representing an estimated consumed travel time for each overseas region as illustrated in FIG. 5B. Accordingly, if a previously scheduled location set in advance on a date is Pusan, and a newly scheduled location to be generated is Seoul, the terminal may search the table in FIG. 5A to determine that an estimated consumed travel time for an attendant to travel to the newly scheduled location is four hours.

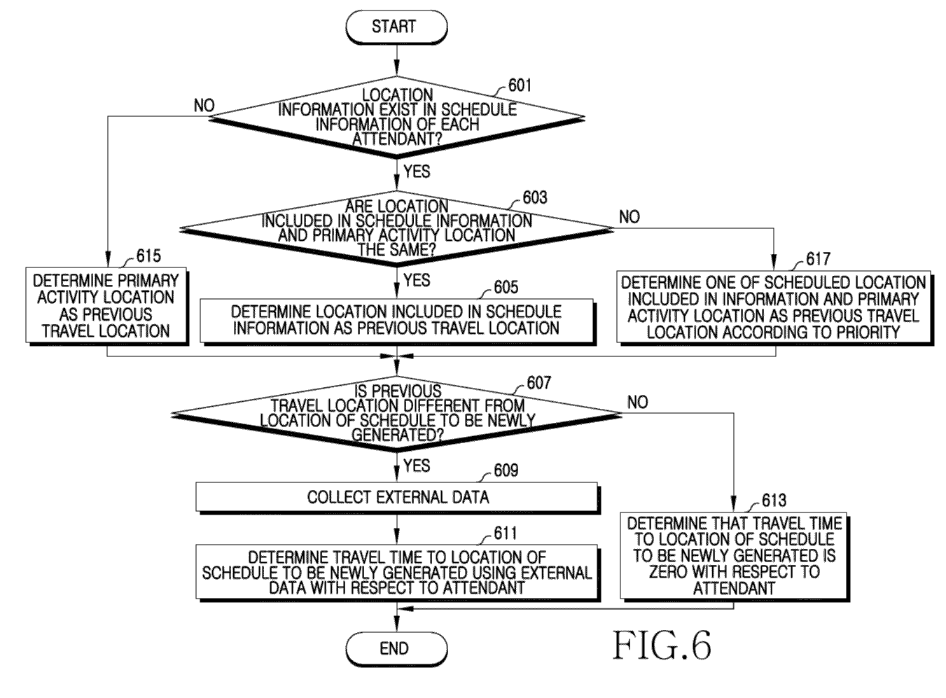

Alternatively, the travel time may be determined by collecting external data and using the collected data. For example, the external data may be a time table and reservation status of a transportation means (e.g., airplanes, railroads, limousine buses, and the like), weather conditions, road status, and the like. When such external data are used, time for travel may be estimated more accurately. Here, a method for determining travel time using the external data is described below in more detail with reference to FIG. 6.

The terminal generates a secondary time limit of the time table using the determined travel time of each attendant in step 311. The secondary time limit of each attendant is directly connected to a corresponding primary time limit as illustrated in FIG. 1B, so that travel time may be expressed on the time table.

The terminal displays the generated primary time limit and secondary time limit of each attendant together with the time table in step 313. Here, the primary time limit and the secondary time limit may be discriminated and expressed differently. For example, the primary time limit and the secondary time limit may be discriminated and expressed differently using color, pattern, transparency, viewing/hiding, and the like. Alternatively, if time limits of a plurality of attendants overlap, all the overlapping time limits are added to generate onetime limit. That is, the overlapping time limits may be generated as one time limit where a time limit starts first and a time limit ends last are connected with each other.

The terminal arbitrarily selects a time frame to be recommended to a user as a suitable time frame in generating a new schedule from time frames excluding the primary time limit and the secondary time limit, and displays the selected time frame in step 315. In the case of FIG. 1B, when the primary time limit and the secondary time limit are applied, a time frame of the time table in which a new schedule may be generated is compressed between 15:00 and 20:30. A time frame between 16:00 and 19:00 within the compressed range is proposed as a recommended time frame to the user. The terminal determines whether the recommended time frame is selected depending on the user's key input in step 317. When the recommended time frame is not selected, the terminal returns to step 315 and arbitrarily selects a newly recommended time frame, different from the previously recommended time frame, from the time frames excluding the primary time limit and the secondary time limit, and displays the newly selected recommended time frame. In contrast, when the newly recommended time frame is selected in step 317, the terminal generates a schedule based on a recommended time frame and stores the generated schedule and information used for determining a travel time of each attendant in step 319. Alternatively, a time frame preferred by the user or a time frame directly input by the user may be selected as the recommended time frame. For example, if the user prefers an evening time frame, and one of 4:00 pm and 8:00 pm is recommended, the terminal may recommend 8:00 pm to the user.

Instead of displaying the recommended time frame, the terminal may allow a user to directly select a time frame suitable for generating a new schedule using the primary time limit and the secondary time limit displayed together with the time table. In this case, instead of steps 315 and 317, a process for determining whether a time frame has been selected by the user's key manipulation is required.

The terminal shares the generated schedule information and information used for determining travel time of each attendant with the attendants in step 321. For example, the terminal may provide the generated schedule information and information determined from the searching in the table in FIG. 5A, that is, the information that an estimated time for an attendant to travel to a location is four hours.

The terminal then ends the operation.

FIG. 6 is a flowchart illustrating a method for determining travel time of an attendant using external data when generating a schedule in a mobile communication terminal according to an exemplary embodiment of the present invention.

Referring to FIG. 6, the terminal obtains schedule information of each attendant set in advance on a date in which a new schedule is to be generated by sharing the schedule information with each attendant, and determines whether location information for a schedule exists in the schedule information of each attendant in step 601.

When the location information for the schedule exists in the schedule information of each attendant in step 601, the terminal determines whether a location included in the scheduled location information of the attendant as the location information is the same as a primary activity location input in advance as information of the attendant in step 603. When the scheduled location information of the attendant as the location information is the same as the primary activity location input in advance as information of the attendant in step 603, the terminal determines the location included in the scheduled information of the attendant as the location information, as a previous travel location in step 605, and proceeds to step 607. Here, the previous travel location denotes a location serving as a start reference of travel time determination.

In contrast, when the schedule location information of the attendant as the location information is different from the primary activity location input in advance as information of the attendant in step 603, the terminal determines one of the scheduled location information of the attendant as the location information and the primary activity location input in advance as the information of the attendant, as a previous travel location based on priority in step 617, and proceeds to step 607. Here, a user may directly determine the priority by viewing schedules before and after a schedule of the attendant. For example, it is assumed that a primary activity region of an attendant is location A. If a schedule of the attendant starts right before a new schedule ends at location B, when a certain schedule is set at location B after the new schedule, location B may be set as a previous traveled location of the attendant. If the attendant does not have a schedule after the new schedule or has a schedule at location A, location A may be set as a previous travel location of the attendant. Alternatively, instead of step 617, the location included in the schedule information of the attendant as the location information and the primary activity location input in advance as the information of the attendant may be provided to a user, so that the user selects a location to be determined as a previous travel location.

In contrast, when the location information of the schedule does not exist in the schedule information of the attendant in step 601, the terminal determines the primary activity location input in advance as the information of the attendant as a previous travel location in step 615, and then proceeds to step 607.

The terminal determines whether the determined previous travel location and a newly scheduled location to be generated are different from each other in step 607. When the determined previous travel location and the newly scheduled location to be generated are different from each other in step 607, the terminal collects external data for a travel path from the determined previous travel location to the newly scheduled location to be generated in step 609. Here, the external data may include information regarding an operation time table and reservation status for a transportation means (e.g., airplanes, railroads, limousine buses, and the like), weather conditions, road status, regional specific information, and the like, for example.

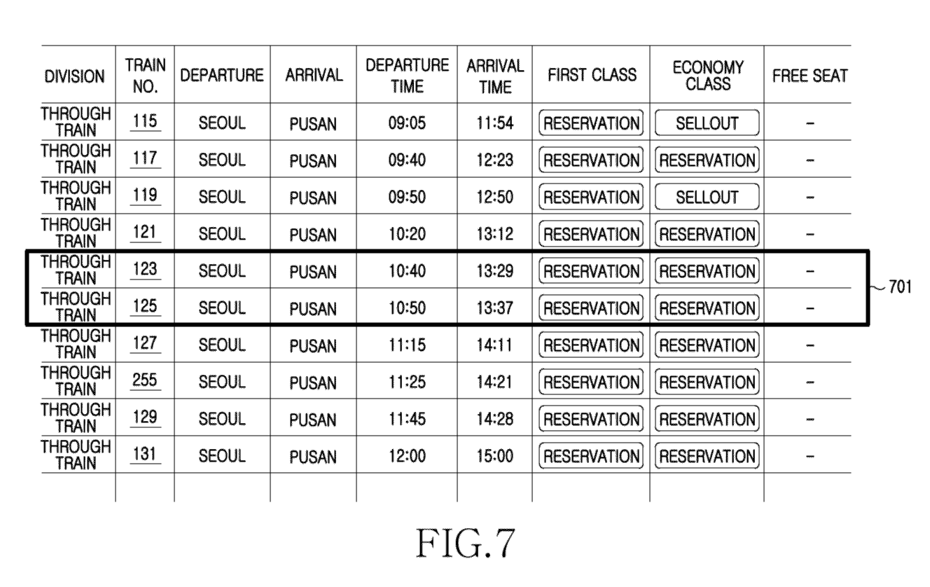

The terminal determines a time for the attendant to travel from the determined previous travel location to the newly scheduled location to be generated using the collected external data in step 611. That is, the terminal selects transportation means to be simulated depending on a distance to which the attendant travels and a regional characteristic, collects an operation time table of the selected transportation means, and then determines a consumed travel time based on the collected data. Here, when selecting the transportation means depending on the traveled distance and the regional characteristic, the terminal may select a plurality of transportation means. The terminal may display consumed travel time determination results for respective transportation means to allow a user to select one of the transportation means. In addition, the terminal may select necessary information depending on a schedule of an attendant during the process of collecting an operation time table of the selected transportation means and use the information for determining the consumed travel time. For example, as illustrated in FIG. 7, if an attendant should depart from a previous travel location after 10:30 and arrive at a newly scheduled location to be generated before 14:00, the terminal may select data 701 that satisfies such a context and uses the selected data in determining the consumed travel time.

Here, the terminal may directly collect the operation time table and the reservation status of the transportation means by accessing an information service web site of transportation means or a travel guide web site, or may collect the operation time table and the reservation status by utilizing Application Program InterfaceOpen (API) opened in the information service web site. Alternatively, the terminal may collect time plan information of an information service web site of each transportation means using a Rich Site Summary (RSS) feed method. The terminal may establish an information server of itself in advance as a service operation and constantly update the information server, thereby collecting relevant information through this service operation.

For example, if attendant A is currently located in New York, USA, and intends to travel to a meeting place in Seoul, the terminal may search for an airport (e.g., JFK Airport) which is nearest to a current location of attendant A in order to determine a time for travel. At this point, GPS information may be used. In addition, the terminal may search for a list of airplanes to Korea departing at a time between 10:00 am and 11:00 am on August 7 from the searched airports, and collect an arrival time using the searched list. The terminal may then collect a time table of a limousine bus that may travel from Incheon International Airport to a meeting place in Seoul, thereby determining a total consumed travel time of attendant A. That is, the total consumed travel time of attendant A may be estimated using time that includes the travel time to the airport, ticket standby time, flight time, and limousine bus time.

In contrast, when the determined previous travel location and the newly scheduled location to be generated are the same in step 607, the terminal determines that time for the attendant to travel to the newly scheduled location to be generated is zero in step 613.

The terminal then ends the operation.

In the case of determining time for the attendant to travel to the newly scheduled location to be generated using the collected external data, the information shared with the attendants and used for determining the travel time in step 321 of FIG. 3 may be information of a travel path, transportation means, reservation status, and the like, for example. Accordingly, the attendant may easily reserve and use transportation means using the shared information. For example, a reservation site of each transportation means may be linked to the shared information to allow the attendant to conveniently make a reservation based on the shared information. In addition, a schedule generator may track travel paths of the attendants afterward using the shared information.

Exemplary embodiments of the present invention have been described using, for example, a method for determining a travel time using location information of each attendant, and recommending a time frame in which a schedule is to be generated using the determined travel time to a user. In an alternate exemplary implementation, a method for determining a location that allows attendants to travel a short distance using location information of the attendants, and providing the determined location as a scheduled location to a user may be proposed. Accordingly, it is possible to narrow a range of a location recommended to a user by limiting selectable locations in advance.

As described above, exemplary embodiments of the present invention provide a suitable time frame to be selected and generate a schedule within a compressed range by generating a time frame in which each attendant actually arrives at a scheduled location and may perform the schedule in the form of a time limit, and by displaying the time frame based on context of an attendant, such as a location, when generating a schedule in a mobile communication terminal. Accordingly, a user who generates a schedule improves their decision-making time, and makes decisions accurately. In addition, external data is collected, for example, information of time tables and reservation status of a transportation means (e.g., airplanes, railroads, limousine buses, and the like), weather conditions, road status, and the like. Travel time by an attendant to depart from a previously scheduled location and arrive at a newly scheduled location is accurately estimated. Accordingly, an accurate time frame in which a schedule may be performed is determined.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for generating a schedule of a mobile communication terminal, the method comprising:
obtaining location information of attendants;
determining a travel time for each attendant to travel to a location of a schedule to be generated using the obtained location information; and
displaying the determined travel time on a time table in the form of a time limit.

2. The method of claim 1, wherein the time limit comprises a primary time limit of the time table using time information obtained through a schedule information sharing and a secondary time limit of the time table using received time limit information.

3. The method of claim 1, further comprising:
obtaining time information of each attendant; and
displaying a start time and an end time of a schedule of each attendant generated in advance on the time table in the form of the time limit using the obtained time information.

4. The method of claim 1, wherein the location information comprises at least one of location information of a schedule of an attendant generated in advance, Global Positioning System (GPS) information of a current location of an attendant, information regarding a primary activity region of an attendant, and information regarding a residential region of an attendant.

5. The method of claim 1, further comprising selecting a time frame of a schedule to be generated from time frames excluding a time frame displayed in the form of the time limit on the time table, and displaying the selected time frame.

6. The method of claim 5, further comprising:
when the time frame of the schedule to be generated is selected, generating the schedule in the selected time frame; and
sharing, with each attendant, at least one of information regarding the generated schedule and information used for determining travel time of each attendant.

7. The method of claim 1, wherein the determining of the travel time for each attendant to travel comprises:
collecting external data for each attendant's travel path from a previous travel location to a newly scheduled location to be generated using the obtained location information; and
determining a time for each attendant to travel from the previous travel location to the newly scheduled location to be generated using the collected external data.

8. The method of claim 7, wherein the external data comprises at least one of a time table and reservation status of a transportation means, weather conditions, and a road status.

9. The method of claim 7, wherein the external data are collected using one of accessing an information service web site of a transportation means, accessing a travel guide web site, utilizing Application Program InterfaceOpen (API) opened in the information service web site, collecting information of an information service web site of the transportation means using a Rich Site Summary (RSS) feed method, and establishing an information server of itself.

10. An apparatus for generating a schedule of a mobile communication terminal, the apparatus comprising:
a schedule information collector for obtaining location information of attendants;
an external data processor for determining travel time for each attendant to travel to a location of a schedule to be generated using the obtained location information; and
a controller for displaying the determined travel time on a time table in the form of a time limit, and providing the travel time to a display unit.

11. The apparatus of claim 10, wherein the time limit comprises a primary time limit of the time table using time information obtained through a schedule information sharing and a secondary time limit of the time table using received time limit information.

12. The apparatus of claim 10, wherein the schedule information collector obtains time information of each attendant, and the controller displays a start time and an end time of a schedule of each attendant generated in advance on the time table in the form of the time limit using the obtained time information and provides the start time and the end time to the display unit.

13. The apparatus of claim 10, wherein the location information comprises at least one of location information of a schedule of an attendant generated in advance, Global Positioning System (GPS) information of a current location of an attendant, information regarding a primary activity region of an attendant, and information regarding a residential region of an attendant.

14. The apparatus of claim 10, wherein the controller selects a time frame of a schedule to be generated from time frames excluding a time frame displayed in the form of the time limit on the time table, and provides the selected time frame to the display unit.

15. The apparatus of claim 14, wherein when the time frame of the schedule to be generated is selected, the controller generates the schedule in the selected time frame, and shares, with each attendant, at least one of information regarding the generated schedule and information used for determining travel time of each attendant.

16. The apparatus of claim 10, further comprising an external data collector for collecting external data for each attendant's travel path from a previous travel location to a newly scheduled location to be generated using the obtained location information,
wherein the external data collector determines a time for each attendant to travel from the previous travel location to the newly scheduled location to be generated using the collected external data.

17. The apparatus of claim 16, wherein the external data comprises at least one of a time table and reservation status of a transportation means, weather conditions, and a road status.

18. The apparatus of claim 16, wherein the external data are collected using one of accessing an information service web site of a transportation means, accessing a travel guide web site, utilizing Application Program InterfaceOpen (API) opened in the information service web site, collecting information of an information service web site of the transportation means using a Rich Site Summary (RSS) feed method, and establishing an information server of itself.
